(19) United States
(12) Patent Application Publication
(10) Pub. No.: US 2019/0005736 A1
(43) Pub. Date: Jan. 3, 2019

(54) METHOD AND APPARATUS FOR CALCULATING A 3D DENSITY MAP ASSOCIATED WITH A 3D SCENE

(71) Applicant: THOMSON Licensing, Issy-les-Moulineaux (FR)

(72) Inventors: Fabien DANIEAU, Rennes (FR); Renaud DORE, Rennes (FR); Francois GERARD, Saint-Grégoire (FR)

(21) Appl. No.: 16/065,032

(22) PCT Filed: Dec. 16, 2016
(86) PCT No.: PCT/EP2016/081581

§ 371 Date: Jun. 21, 2018

(30) Foreign Application Priority Data
Dec. 21, 2015 (EP) 15307086.7

(51) Int. Cl. G06T 19/20; G06T 15/20

(52) U.S. Cl. CPC G06T 19/20; G06T 2219/2004; G06T 15/20

(57) ABSTRACT

The present disclosure relates to methods, apparatus or systems for calculating a 3D density map (33) for a 3D scene (32) in which significant objects have been annotated and associated with a significance weight. The 3D density map is computed in function of the location of the significant objects and the location of at least one virtual camera in the 3D scene. The space of the 3D scene is split in regions and a density is computed for each regions according to the significant weights. The 3D density map is transmitted to an external module configured to reorganize the scene according to the 3D density map.

### 1. TECHNICAL FIELD

The present disclosure relates to the domain of calculating a 3D density map for a 3D scene in which some objects are associated with significance weight. Such a density map is used, for example, for preparing a 3D scene for optimizing the placement of accessory or decorative objects or volumes in order to preserve the viewing of significant objects by observers. Optimized 3D scenes are rendered by a 3D engine, for instance, on a head mounted display (HMD) or a TV set or a mobile device such as a tablet or a smartphone.

### 2. BACKGROUND

A 3D modelled scene is composed of objects of a plurality of natures. Some objects of a 3D modelled scene are considered as important or significant. These are the visual elements of the narration, the story or the interaction; these objects may be of any kind: they can be animated characters, static objects or animated volumes (e.g. clouds, smoke, swarms of insects, flying leaves or schools of fish). 3D scenes are also made of static objects which constitute the scenery of the scene (e.g. ground or floor, buildings, plants . . . ) and of animated decorative objects or volumes.

3D engines render 3D scenes from the point of view of a virtual camera located within the space of the 3D scene. A 3D engine can perform several rendering of one 3D scene from the point of view of a plurality of virtual cameras. Depending on the applications in which 3D scenes are used, it is not always possible to anticipate the moving of cameras.

When the moving of cameras is controlled or constraint (e.g. in video games or in movies), 3D scenes are modelled in a way not to hide important or significant objects. Decorative objects and volumes are placed not to appear between the cameras and the significant objects.

Animated objects and volumes self-organization methods exist. See for example “Towards Believable Crowds: A Generic Multi-Level Framework for Agent Navigation” by Wouter G. van Toll, Norman S. Jaklin and Roland Geraerts in ICT.OPEN 2015.

### 3. SUMMARY

The purpose of the present disclosure is to calculate a 3D density map for a 3D scene in which at least one object has been annotated as significant and associated with a significance weight. An example use of the calculated 3D density map is the automatic reorganization of decorative animated objects and volumes of the 3D scene.

The present disclosure relates to a method of calculating a 3D density map for a 3D scene, the method comprising:
for each first object of said set, determining a first region of a 3D space of the scene that is situated between the at least one virtual camera and the first object, and associating the first region with the first object,
determining a second region of the 3D space that is the complementary of the union of every first regions,
associating a first density value with each said first region and a second density value with said second region, each first density value being smaller than or equal to the second density value.

According to a particular characteristic, the method further comprises determining a third region within said each first region, the third region being the part of the first region in a field of view of said at least one virtual camera and determining a fourth region that is the complementary of the third region within each said first region, a third density value being associated with each third region and a fourth density value being associated with each fourth region, the third density value being smaller than or equal to the first density value and the fourth density value being greater than or equal to the first density value and smaller than or equal to the second density value.

In a variant, the method further comprises determining a fifth region within said second region, the fifth region being the part of the second region in a field of view of said at least one virtual camera and determining a sixth region that is the complementary of the fifth region within the second region, a fifth density value being associated with the fifth region and a sixth density value being associated with the sixth region, the fifth density value being greater than or equal to the first density value and smaller than or equal to the second density value and the sixth density value being greater than or equal to the second density value.

According to an embodiment, the first density value is a function of said weight, the greater the weight, the smaller the first density value.

Advantageously, the weight associated with said each first object is varying along a surface of said first object, the first density value varying within the first region according to said weight.

In a variant, the method further comprises detecting a change in parameters of said at least one first object or detecting a change in parameters of said at least one virtual camera, a second 3D density map being computed according to the changed parameters.

According to a particular characteristic, the method further comprises transmitting the 3D density map to a scene reorganizer, the scene reorganizer being configured to take the 3D density map into account to reorganize the 3D scene and the scene reorganizer being associated with a 3D engine, the 3D engine configured to render an image representative of the reorganized 3D scene from a point of view of one of said at least one virtual camera.

The present disclosure also relates to an apparatus configured for calculating a 3D density map for a 3D scene, a weight being associated with each first object of a set comprising at least one first object, said 3D density map computed in function of a location of at least one virtual camera in the 3D scene, the apparatus comprising a processor configured to:
for each first object (11, 25) of said set, determine a first region (13) of a 3D space of the scene that is situated between the at least one virtual camera (12) and the first object (11, 25), and associate the first region with the first object,
determine a second region (14) of the 3D space that is the complementary of the union of every first regions,
and associate a first density value with said each first region (13) and a second density value with said second region (14), each first density value being smaller than or equal to the second density value.

The present disclosure also relates to a computer program product comprising instructions of program code for executing, by at least one processor, the abovementioned method of determining an aiming direction of a camera, when the program is executed on a computer.

The present disclosure also relates to a non-transitory processor readable medium having stored therein instructions for causing a processor to perform at least the abovementioned method of composing an image representative of a texture.

### 4. LIST OF FIGURES

The present disclosure will be better understood, and other specific features and advantages will emerge upon reading the following description, the description making reference to the annexed drawings wherein:

FIG. 1 illustrates an example of a 3D scene composed of an object annotated as significant in the scene and of a virtual camera. The space of the 3D scene is divided in two regions, according to a specific embodiment of the present principles;

FIG. 2a illustrates an example of a 3D scene like the one of FIG. 1 and divided in four regions, according to a specific embodiment of the present principles;

FIG. 2b illustrates an example of a 3D scene, like the ones of FIGS. 1 and 2a, which contains a virtual camera and two objects annotated as significant within the 3D scene, according to a specific embodiment of the present principles;

FIG. 3 diagrammatically shows a system comprising a module to calculate regions of FIGS. 1, 2a and 2b, according to a specific embodiment of the present principles;

FIG. 4 shows a hardware embodiment of an apparatus configured to calculate the 3D density map of FIG. 3 for a 3D scene as illustrated in FIGS. 1, 2a and 2b, according to a specific embodiment of the present principles;

FIG. 5 diagrammatically shows an embodiment of a method of calculating a 3D density map as implemented in a processing device such as the device of FIG. 4, according to a non-restrictive advantageous embodiment of the present principles.

### 5. DETAILED DESCRIPTION OF EMBODIMENTS

The subject matter is now described with reference to the drawings, wherein like reference numerals are used to refer to like elements throughout. In the following description, for purposes of explanation, numerous specific details are set forth in order to provide a thorough understanding of the subject matter. It is understood that subject matter embodiments can be practiced without these specific details.

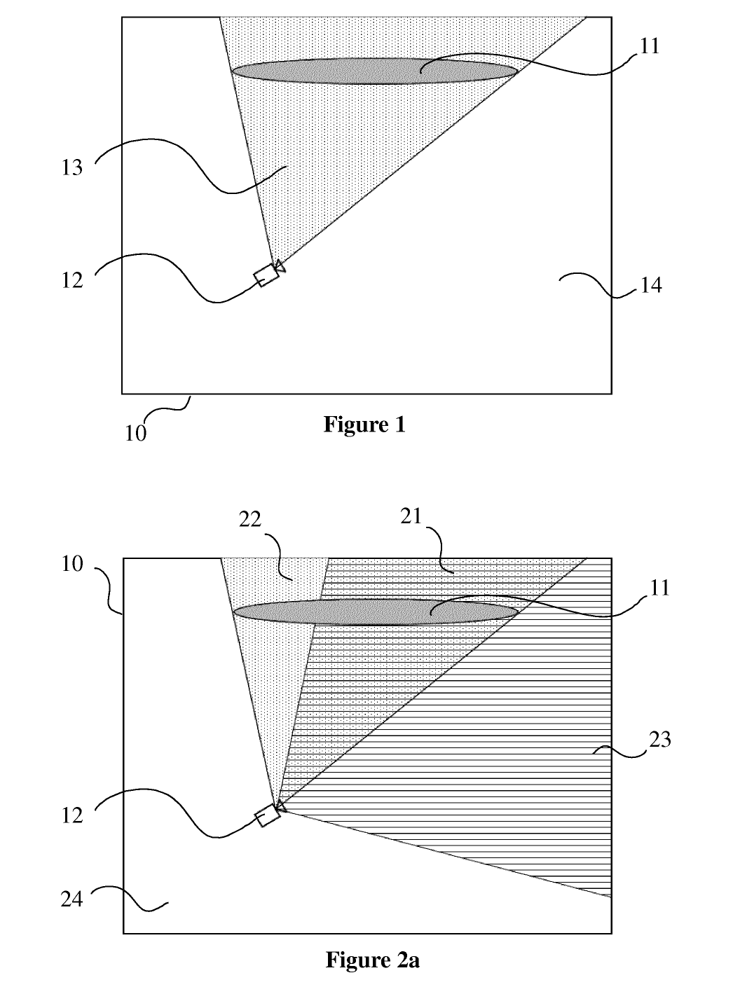

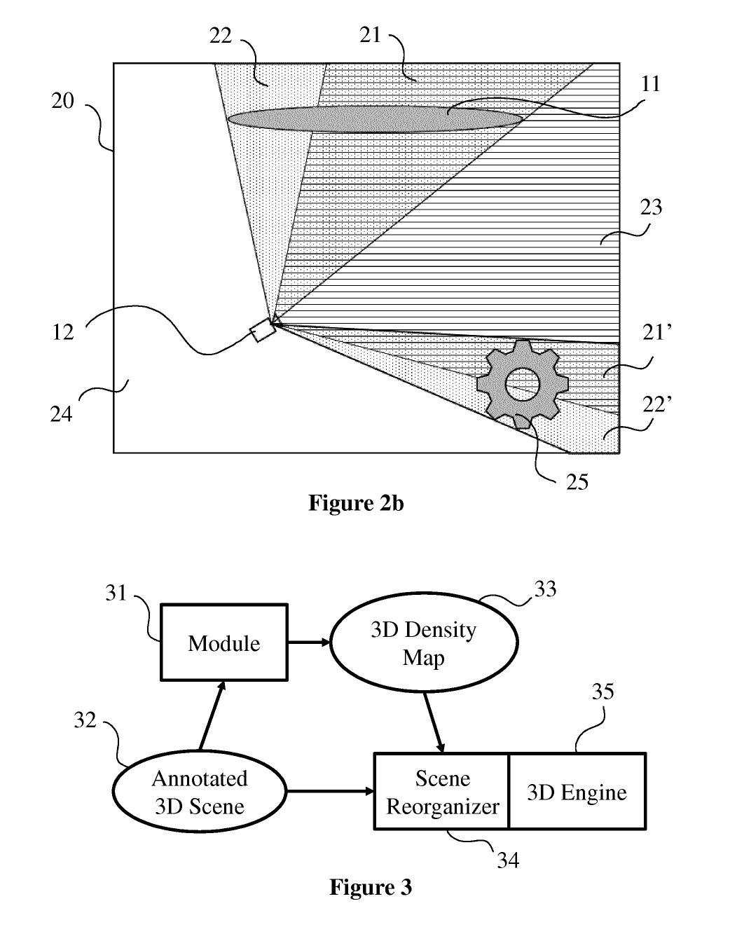

For the sake of clarity, FIGS. 1, 2a and 2b illustrate examples in two dimensions. It is understood that the present principles are extendable to a third dimension.

The present principles will be described in reference to a particular example of a method of calculating a 3D density map according to a 3D scene in which significant objects have been associated with weights. On FIGS. 1, 2a and 2b, only significant objects are represented. It is understood that 3D scenes may contain objects that are not annotated as significant (i.e. not associated with a significance weight). These objects are parts of the scenery of the scene such as buildings, ground or plants. Scenery's objects cannot move or change their shape in important proportions. Other objects have a decorative role within the scene such as animated volumes (e.g. smoke, schools of fish, rain or snowflakes) or animated objects (e.g. a passer-by, a vehicle or an animal). Decorative objects can be moved away or have their shape distorted in order to free the space they occupy.

The present method determines regions within the space of the 3D scene according to the location of the virtual cameras and the location of the weighted significant objects. Each region is associated with a density value that is representative of the significance of the region. An example use of the calculated 3D density map is the automatic reorganization of decorative animated objects and volumes of the 3D scene. Decorative animated objects will self-organize, for instance, in order to minimize their occupation of regions with a high level of significance. To do that, methods of self-organizing animated objects require information that take the form of a 3D map of the density of significance of space. As a result, the location of decorative animated objects is dynamically adapted according to the location of the at least one virtual camera in order not to mask key objects to every users from their point of view.

FIG. 1 illustrates an example of a 3D scene 10 composed of an object 11 annotated as significant in the scene and of a virtual camera 12. On FIG. 1, the space of the 3D scene is divided in two regions 13 and 14. The first region 13 corresponds to the 3D space that is located between the virtual camera 12 (represented as a point) and the significant object 11. In this example, the first region 13 is a frustum which points to the virtual camera 12 and which is defined by the contours of the object 11 as drawn from the point of view of the virtual camera 12. If the object 11 is transparent, the first region 13 is the pyramid obtained by extending the frustum beyond the object 11. The first region 13 is associated with the object 11. The second region 14 is the complementary of the first region 13 in the space of the 3D scene.

According to the present principles, a density value is a scalar representative of the significance of a region. The calculation of the density value of a region is based on the relative locations and positions of at least one camera and a set of first objects (like object 11) associated with significance weights. The higher the significance weight, the more significant the region. The more significant the region, the lower the density. Indeed, low density regions will be interpreted as regions, for instance, to be freed from decorative animated objects and volumes. A first density value D1 is associated with the first region 13 and a second density D2 value is associated with the second region 14, the first density value being lower than or equal to the second density value: D1≤D2.

Significant objects are associated with a weight. The weight of a significant object represents the significance of the object within the 3D scene. For example, if the significance represents the importance for an object to be viewed, the more the object has to be seen, the higher its weight. The density attributed to the first region is attributed in function of the weight of the object the region is associated with following the principle: the higher the weight, the lower the density. For example, the weight w of an object belongs to the interval [0, 100]. The density D1 of the first region is calculated, for instance, according to one of the following equations:

D1=100−w

$$D 1 = \frac{k}{w} ,$$

with k a constant, for instance 1 or 10 or 100;

$$D 1 = k \cdot cos ( \frac{π w}{100} ) ,$$

with k a constant, for instance 1 or 10 or 100;

The density D2 of the second region is greater than or equal to D1. In a variant, D2 is calculated with a function applied on D1 such as one of the following ones:

D2=D1+k, with k a constant, for instance 0 or 1 or 5 or 25;

$$D 2 = D 1 + \frac{D 1}{max ( D 1 )}$$

According to an embodiment, the weight of a significant object varies along its surface. The first region 13 is associated with a radial gradient of density. Indeed the density within the first region is determined per lines between the virtual camera 12 and points on the surface of the object, the density being calculated according to the weight at each point. As the first region is associated with a variable density, the constraint on the density of the second region is adapted, for instance, to min(D1)<D2. In a variant, the constraint on D2 applies on the density D1 on the surface between the two regions: the value of the second density varies according to the values of the first density at the contact surface between the two regions.

The 3D space is split in voxels. A voxel represents a cube in a grid in three-dimensional space. For example, voxels are cubes of regular size. In a variant voxels are cubes of different sizes. Each voxel is associated with the density value of the region the voxel belongs to. Voxels belonging to several regions are associated with the minimum density value for example. In a variant regions are represented by data representative of the pyramid each region shapes; each region being associated with a density. In another variant, the space of densities is represented with splines associated with a parametric function.

FIG. 2a illustrates an example of a 3D scene 10 divided in four regions: a third region 21, a fourth region 22, a fifth region 23 and a sixth region 24. The field of view of the virtual camera 12 is the area of the inspection captured by the sensor of the camera. The field of view of the virtual camera 12 is distributed around the aiming direction of said virtual camera. The third region 21 corresponds to the part of the first region 13 of FIG. 1, the part that belongs to the field of view of the virtual camera 12. In other words, the space of the third region 21 is at the same time between the camera 12 and the object 11 and within the field of view of the virtual camera 12. As a part of the first region, the third region 21 is associated with the significant object 11. The fourth region 22 is the part of the first region that is outside of the field of view of the virtual camera 12. The fourth region 22 is the part of the environment that is located between the camera and the significant object 11 and that is not seen by the camera. Density value for a region is representative of the region's significance. Because the third region 21 is within the field of view of the virtual camera 12, the significance of the third region 21 is greater than the significance of the fourth region 22. The density value D3 associated with the third region 21 is lower than or equal to the density D1 associated with the first region. According to the same principles, the density D4 associated with the fourth region 22 has a value greater than or equal to D1 and lower than or equal to D2: D3≤D1≤D4≤D2. In a variant, D3 and D4 are functions of D1.

The fifth region 23 is the part of the second region that belongs to the field of view of the virtual camera 12. The sixth region 24 is the complementary of the fifth region 23 within the second region. The sixth region 24 is the part of the 3D space that is neither between the virtual camera 12 and any of the significant objects, nor within the field of view of the virtual camera 12. According to these definitions, density values D5 and D6 respectively associated with the fifth region 23 and the sixth region 24 obey the following relation: D1≤D5≤D2≤D6. In a variant, D5 and D6 are functions of D1.

According to a variant, a constraint D4≤D5 is applied as the fifth region 23 is considered more significant than the fourth region 22. According to another variant, no relation of order is set between D4 and D5 as the fifth region 23 is not in contact with the fourth region 22.

FIG. 2b illustrates an example of a 3D scene 20 which contains a virtual camera 12 and two objects 11 and 25 annotated as significant within the 3D scene. A first region is determined for each of the significant objects 11 and 25 of the scene. Each first region is associated with the significant object the region has been determined out of. Indeed, objects may have different weights and associated densities will be different. A unique second region is determined as the complementary of the union of the first regions.

When a significant object is located behind another one, only the part of the back object visible from the location of the camera is taken into account to shape the corresponding first region. In a variant, if the front significant object is transparent, the two first regions are defined independently and the two first regions totally or partially overlap.

If the scene comprises several virtual cameras, several first regions are associated to each significant object. As these first regions partially overlap, they are gathered in a unique region. Indeed, as the density of a first region depends on a weight associated with the significant object the first region is shaped out of, if two first regions are shaped out of the same significant object, the two first regions have the same density.

In a variant, the density of a first region depends on a weight associated with the virtual camera 12 and/or on a distance between the virtual camera 12 and the significant object the region has been shaped out of. In this variant, two first regions for one significant object are kept independent as they may have different densities.

When two regions (first, second, third, fourth, fifth or sixth regions) overlap, the one with the lowest density is preferred for the 3D space the regions share.

FIG. 3 diagrammatically shows a system comprising a module 31 implementing the present principles. The module 31 is a functional unit, which may or not be in relation with distinguishable physical units. For example, the module 31 may be brought together in a unique component or circuit, or contribute to functionalities of a software. A contrario, the module 31 may potentially be composed of separate physical entities. The apparatus which are compatible with the present principles are implemented using either pure hardware, for example using dedicated hardware such ASIC or FPGA or VLSI, respectively «Application Specific Integrated Circuit», «Field-Programmable Gate Array», «Very Large Scale Integration», or from several integrated electronic components embedded in a device or from a blend of hardware and software components. The module 31 takes a representation of a 3D scene 32 as entry. Significant objects of the 3D scene are annotated with weights.

Some of existing 3D scenes formats allow the modeller to associate metadata with objects of the scene in addition to geometrical and visual information. For instance, X3D or 3DXML allow this addition of user-defined tags in their format. Most of 3D scene formats allow the possibility to associate an object with a program script, for its animation for example. Such a script can comprise a function which returns a scalar representative of a weight when executed.

Obtaining information representative of the 3D scene can be viewed either as a process of reading such an information in a memory unit of an electronic device or as a process of receiving such an information from another electronic device via communication means (e.g. via a wired or a wireless connection or by contact connection).

Calculated 3D density map is transmitted to a device configured to reorganize the 3D scene, especially the decorative objects of the 3D scene, according to the 3D density map. The reorganized scene is used by a 3D engine to render at least one image of the 3D scene from the point of view of a virtual camera. In a variant, the 3D density map calculation module is implemented in the same device than the scene reorganiser and/or the 3D engine.

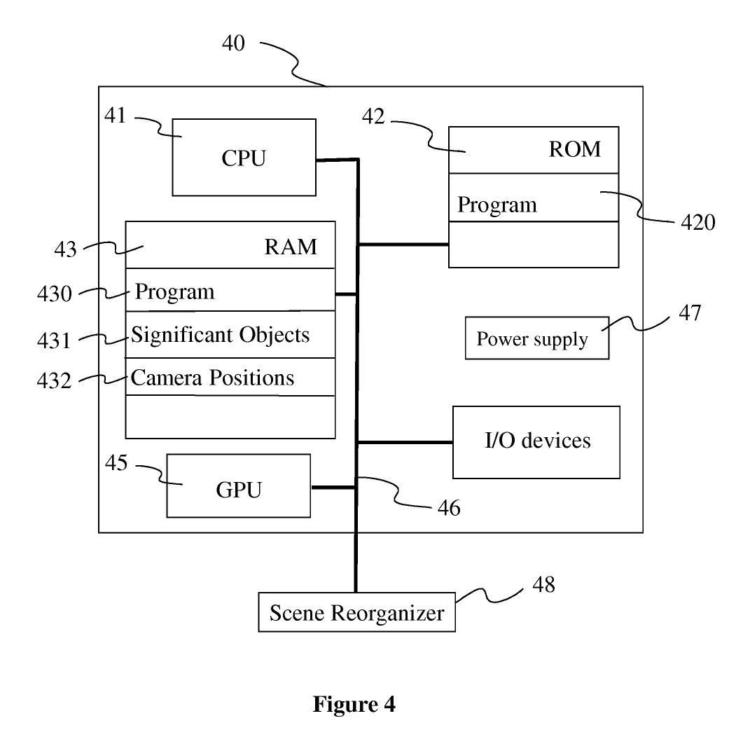

FIG. 4 shows a hardware embodiment of an apparatus 40 configured to calculate a 3D density map for a 3D scene. In this example, the device 40 comprises the following elements, connected to each other by a bus 46 of addresses and data that also transports a clock signal:
a microprocessor 41 (or CPU),
an optional graphics card 45,
a non-volatile memory of ROM (Read Only Memory) type 42,
a Random Access Memory or RAM 43, the graphics card 45 may embed registers of random access memory
A set of I/O (Input/Output) devices such as for example a mouse, a webcam, etc. that are not detailed on FIG. 4, and
a power source 47.

Advantageously, the device 40 is connected to a device 48 configured to reorganize a 3D scene according to a 3D density map. In a variant, the device 48 is connected to the graphic card 66 via the bus 63. In a particular embodiment, the device 48 are integrated to the device 40.

It is noted that the word “register” used in the description of memories 42 and 43 designates in each of the memories mentioned, both a memory zone of low capacity (some binary data) as well as a memory zone of large capacity (enabling a whole program to be stored or all or part of the data representative of data calculated or to be displayed).

When switched-on, the microprocessor 41, according to the program in the register 420 of the ROM 42 loads and executes the instructions of the program in the RAM 430.

The random access memory 43 notably comprises:
in a register 430, the operating program of the microprocessor 41 responsible for switching on the device 40,
in a register 431, data representative of the objects annotated as significant in the 3D scene, in particular their shape, their location and the weight associated with each significant object,
in a register 432, data representative of the virtual cameras of the 3D scene, in particular their location and their field of view,

According to one particular embodiment, the algorithms implementing the steps of the method specific to the present disclosure and described hereafter are advantageously stored in a memory GRAM of the graphics card 45 associated with the device 40 implementing these steps.

According to a variant, the power supply 47 is external to the device 40.

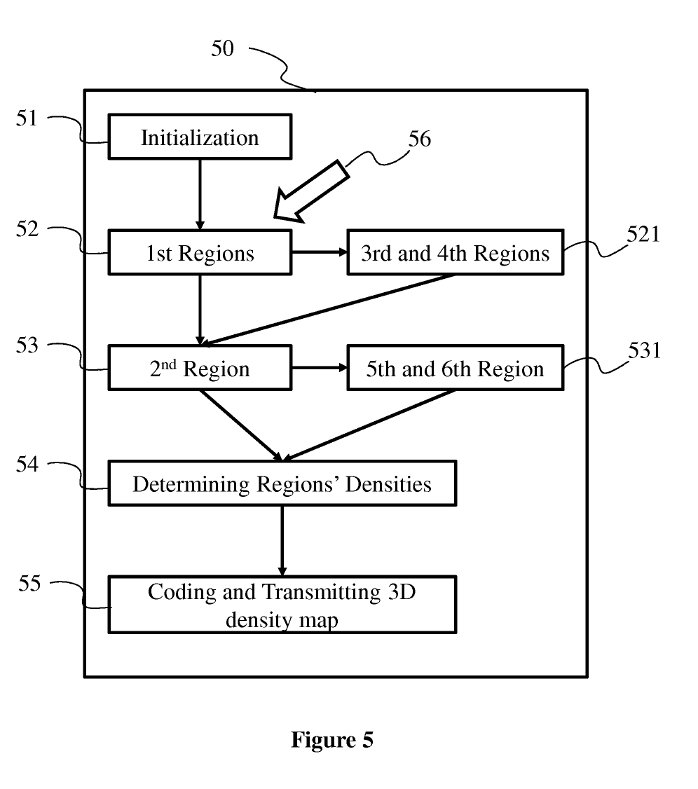

FIG. 5 diagrammatically shows an embodiment of a method 50 of calculating a 3D density map as implemented in a processing device such as the device 40 according to a non-restrictive advantageous embodiment.

In an initialization step 51, the device 40 obtains a 3D scene annotated with weights for significant objects and comprising information about the virtual cameras. It should also be noted that a step of obtaining an information in the present document can be viewed either as a step of reading such an information in a memory unit of an electronic device or as a step of receiving such an information from another electronic device via communication means (e.g. via a wired or a wireless connection or by contact connection). Obtained 3D scene information are stored in registers 431 and 432 of the random access memory 43 of the device 40.

A step 52 is executed once the initialization has been completed. Step 52 consists in determining (i.e. computing or calculating) a first region 13 (as illustrated in FIG. 1) for each significant objects (according to information stored in register 431 of the RAM 43). Each calculated first region is associated with the significant object, on the base of which the first region has been shaped.

According to a variant, a step 521 may be executed once the step 52 has been completed. In this step 521, first regions calculated at step 52 are split in third and fourth regions according to the cameras' field of view.

A step 53 is executed when first, third and fourth regions have been determined. At this step 53, the second region is determined as the space of the 3D scene that does not belong to one of the first, third or fourth regions. There is only one second region which is not associated to any of the significant objects.

In a variant, a step 531 is executed after the step 53 has been completed. Step 531 consist in dividing the second region in a fifth region (the part of the second region that is within the field of view of at least one virtual camera) and a sixth region (that is determined as the complementary of the fifth region within the second region).

A step 54 is executed once the space of the 3D scene has been divided in regions. Step 54 consists in attributing a density value to each determined region. For first, third and fourth regions, the density is calculated according to the nature of the region and according to the weight of the significant object the region is associated with. For second, fifth and sixth regions, the density is computed according to the nature of the region and according to the first, third and fourth regions' densities, the region shares a border with.

An optional step 55 is executed once regions and their densities have been calculated. Step 55 consists in coding a 3D density map to provide an information representative of the distribution of densities over the 3D space. The coded 3D density map is transmitted to a scene reorganizer 34, 48.

In a particular embodiment, the map is calculated again when a change 56 is detected in the shape or the location or the weight of significant objects or when a change 56 is detected in the location or in the field of view of at least one of the virtual cameras. The method executes the step 52 again. In a variant, several steps of the method are active at the same time and the calculation of a 3D density map may be under progress while the calculation of a new 3D density map starts.

Naturally, the present disclosure is not limited to the embodiments previously described. In particular, the present disclosure is not limited to a method of calculating a 3D density map for a 3D scene but also extends to a method of transmitting a 3D density map to a scene reorganizer and to a method of reorganizing the 3D scene on the base of the calculated 3D density map. The implementation of calculations necessary to compute the 3D density map are not limited to an implementation in a CPU but also extends to an implementation in any program type, for example programs that can be executed by a GPU type microprocessor.

The implementations described herein may be implemented in, for example, a method or a process, an apparatus, a software program, a data stream or a signal. Even if only discussed in the context of a single form of implementation (for example, discussed only as a method or an apparatus), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, smartphones, tablets, computers, mobile phones, portable/personal digital assistants (“PDAs”), and other devices.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analogic or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method of reorganizing a second object of a 3D scene comprising a first object, said second object being an animated object or an animated volume, the method comprising:
determining a first region of a 3D space of the scene that is situated between a virtual camera of the 3D scene and the first object,
determining a second region of the 3D space that is the complementary of the first regions,
associating first density value with the first region and a second density value with the second region, the first density value being smaller than or equal to the second density value, and
reorganizing said second object by minimizing an occupation density of said second object in regions with a low density.

2. The method according to claim 1, further comprising determining a third region within said first region, the third region being the part of the first region in a field of view of said virtual camera and determining a fourth region that is the complementary of the third region within said first region, a third density value being associated with the third region and a fourth density value being associated with the fourth region, the third density value being smaller than or equal to the first density value and the fourth density value being greater than or equal to the first density value and smaller than or equal to the second density value.

3. The method according to claim 2, further comprising determining a fifth region within said second region, the fifth region being the part of the second region in a field of view of said virtual camera and determining a sixth region that is the complementary of the fifth region within the second region, a fifth density value being associated with the fifth region and a sixth density value being associated with the sixth region, the fifth density value being greater than or equal to the first density value and smaller than or equal to the second density value and the sixth density value being greater than or equal to the second density value.

4. The method according to claim 1, wherein a weight is associated with the first object and wherein the first density value is a function of said weight, the greater the weight, the smaller the first density value.

5. The method according to claim 4, wherein said weight associated with the first object is varying along a surface of said first object, the first density value varying within the first region according to said weight.

6. The method according to claim 1, further comprising detecting a change in parameters of said first object or detecting a change in parameters of said virtual camera, a 3D density map being computed according to the changed parameters.

7. (canceled)

8. An apparatus configured to reorganize a second object of a 3D scene comprising a first object, said second object being an animated object or an animated volume, the apparatus comprising a memory associated with a processor configured to:
determine a first region of a 3D space of the scene that is situated between a virtual camera of the 3D scene and the first object,
determine a second region of the 3D space that is the complementary of the first region,
associate a first density value with the first region and a second density value with the second region, the first density value being smaller than or equal to the second density value, and
reorganize said second object by minimizing an occupation density of said second object in regions with a low density.

9. The apparatus according to claim 8, wherein the processor is further configured to determine a third region within said first region, the third region being the part of the first region in a field of view of said virtual camera and determining a fourth region that is the complementary of the third region within the first region, a third density value being associated with the third region and a fourth density value being associated with the fourth region, the third density value being smaller than or equal to the first density value and the fourth density value being greater than or equal to the first density value and smaller than or equal to the second density value.

10. The apparatus according to claim 9, wherein the processor is further configured to determine a fifth region within said second region, the fifth region being the part of the second region in a field of view of said virtual camera and determine a sixth region that is the complementary of the fifth region within the second region, a fifth density value being associated with the fifth region and a sixth density value being associated with the sixth region, the fifth density value being greater than or equal to the first density value and smaller than or equal to the second density value and the sixth density value being greater than or equal to the second density value.

11. The apparatus according to claim 8, wherein a weight is associated with the first object and wherein the first density value is function of said weight, the greater the weight, the smaller the first density value.

12. The apparatus according to claim 11, wherein said weight associated with the first object is varying along a surface of said first object, the first density value varying within the first region according to said weight.

13. The apparatus according to claim 8, further comprising a detector for detecting a change in parameters of the first object or detecting a change in parameters of the virtual camera, a 3D density map being computed according to the changed parameters.

14. (canceled)

15. A non-transitory processor readable medium having stored therein instructions for causing a processor to perform at least the steps of the method according to claim 1 to.
